(19) United States
(12) Patent Application Publication
(10) Pub. No.: US 2019/0187794 A1
(43) Pub. Date: Jun. 20, 2019

(54) Systems and Methods for Pneumatic Pressure Haptic Controllers

(71) Applicant: Immersion Corporation, San Jose, CA (US)

(72) Inventor: Vahid Khoshkava, Montreal (CA)

(73) Assignee: Immersion Corporation, San Jose, CA (US)

(21) Appl. No.: 15/848,855

(22) Filed: Dec. 20, 2017

(51) Int. Cl. G06F 3/01

(52) U.S. Cl. CPC G06F 3/016; G06F 2203/013

(57) ABSTRACT

Systems and methods for pneumatic pressure haptic controllers are disclosed. One disclosed system for includes: a controller; an impeller motor coupled to the controller; and a processor coupled to the impeller motor and configured to: receive a controller signal; determine a haptic signal based in part on the controller signal; and output the haptic signal to the impeller motor to output a haptic effect.

### FIELD OF THE INVENTION

The present application relates to the field of user interface devices. More specifically, the present application relates to virtual reality controllers with haptics.

### BACKGROUND

Virtual Reality (“VR”) applications have become increasingly popular. Handheld controllers, including touch-enabled devices, are often used to interact with such applications. Some such devices may be configured with haptic actuators that provide vibrotactile effects to users of the VR applications, however, such devices lack the capability to provide kinesthetic feedback. Accordingly, there is a need for kinesthetic haptic effects in virtual reality environments.

### SUMMARY

Various examples are described for systems and methods for pneumatic pressure haptic controllers. In one embodiment, a system for a pneumatic pressure haptic controller comprises: a controller; an impeller motor coupled to the controller; and a processor coupled to the impeller motor and configured to: receive a controller signal; determine a haptic signal based in part on the controller signal; and output the haptic signal to the impeller motor to output a haptic effect.

In another embodiment, a method according to the present disclosure comprises: receiving a controller signal; determining a haptic signal based in part on the controller signal; and outputting the haptic signal to an impeller motor to output a haptic effect.

In yet another embodiment, a computer readable medium may comprise program code, which when executed by a processor is configured to enable the processor to perform operations associated with pneumatic pressure haptic controllers. This program code may comprise program code configured, when executed by a processor, to: receive a controller signal; determine a haptic signal based in part on the controller signal; and output the haptic signal to an impeller motor to output a haptic effect.

These illustrative embodiments are mentioned not to limit or define the limits of the present subject matter, but to provide examples to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1A shows an illustrative system for pneumatic pressure haptic controllers according to one embodiment of the present disclosure.

FIG. 1B shows another illustrative system for pneumatic pressure haptic controllers according to one embodiment of the present disclosure.

FIG. 1C shows another illustrative system for pneumatic pressure haptic controllers according to one embodiment of the present disclosure.

FIG. 2 shows another illustrative system for pneumatic pressure haptic controllers according to one embodiment of the present disclosure.

FIG. 3 is a flow chart of method steps for one example embodiment for controlling pneumatic pressure haptic controllers according to one embodiment of the present disclosure.

FIG. 4A is a graph comparing air velocity to linear force according to one embodiment of the present disclosure.

FIG. 4B is a graph comparing air velocity to linear force according to one embodiment of the present disclosure.

FIG. 5A is a graph comparing air velocity to Revolutions Per Minute (RPM) according to one embodiment of the present disclosure.

FIG. 5B is a graph comparing impeller radius to force output according to one embodiment of the present disclosure.

### DETAILED DESCRIPTION

Reference will now be made in detail to various and alternative illustrative embodiments and to the accompanying drawings. Each example is provided by way of explanation, and not as a limitation. It will be apparent to those skilled in the art that modifications and variations can be made. For instance, features illustrated or described as part of one embodiment may be used in another embodiment to yield a still further embodiment. Thus, it is intended that this disclosure include modifications and variations as come within the scope of the appended claims and their equivalents.

### Illustrative Example of a Device for Pneumatic Pressure Haptic Controllers

One illustrative embodiment is a gaming system that includes one or more Virtual Reality (VR) controllers in wireless communication with the gaming system. As used herein, the term Virtual Reality includes a virtual environment or an augmented environment, e.g., Augmented Reality (AR). The VR controller allows a user to interact with a virtual environment and with objects in the environment. For example, as the user moves the VR controller, one or more sensors may detect the movement and this movement may be translated to corresponding movement in the virtual environment.

The VR controller may output haptic effects (e.g., touch or feel based effects) to enhance the reality of the interaction. In the illustrative embodiment, the VR controller is configured to output haptic effects using pneumatic pressure. In one embodiment, the pneumatic pressure is supplied by one or more impeller motors (e.g., a rotary motor to turn a fan or blower). Other embodiments may us other components to generate pneumatic pressure, e.g., a rotary fan, a centrifugal fan, a diaphragm, a bellows, a pneumatic cylinder, or some other device configured to generate air flow.

In the illustrative embodiment, when the impeller motor is activated it rotates the fan, outputting forces which the user feels through the VR controller. These forces may comprise thrust force (the force caused by air displaced by the fan) and rotary or torque forces as the fan accelerates and spins. The force felt by the user will be the combination of these forces. Embodiments described herein may rely on the combined force from the air flow and torque to output haptic effects.

In the illustrative embodiment, force output by the one or more impeller motors enables the VR device to simulate multiple haptic effects. For example, in one embodiment the user may rotate an object in a virtual environment, e.g., a doorknob, steering wheel, or other rotary object. As the user rotates the object the VR controller may determine a rotary haptic effect and output control signals to the VR controller that cause the impeller motors to activate. In the illustrative embodiment, the impeller motors output forces simulating the forces a user feels when rotating a door knob. Similarly, in the illustrative embodiment additional forces may be output, e.g., a resistive force as a user moves his or her hand through virtual water or forces that simulate weight as a user lifts a virtual ball.

In the illustrative embodiment, the VR controller may comprise a plurality of pneumatic pressure generating devices at different positions. For example, the illustrative embodiment may comprise a plurality of impeller motors at different positions. Further, the illustrative embodiment may comprise a plurality of different types of pneumatic pressure generating devices, e.g., on or more of an impeller motor, a bellows, a diaphragm, and/or a cylinder. In the illustrative embodiment, including pneumatic pressure generating devices at different positions enables a plurality of different forces to be output by the VR controller.

Further, in the illustrative embodiment, one or more of the pneumatic pressure generating devices may be configured to be removed and replaced at different locations on the VR controller. For example, a pneumatic pressure generating device may be incorporated into a module that can be removed and repositioned in different locations on the VR controller. In one embodiment, the module may be magnetically coupled to the VR controller. Magnetic coupling may allow a user to reposition pneumatic pressure generating devices or modules to different locations throughout the VR controller. This may enable the VR controller to output a broader range of forces to the user.

Further, in some embodiments, the VR controller may comprise one or more built-in pneumatic pressure generating devices. In such an embodiment, the user may be able to replace components associated with the one or more pneumatic pressure generating devices. For example, the user may be able to replace one or more of an impeller, blades (e.g., blades of different size, weight, blade pitch), a nozzle, an opening on a bellows or pneumatic piston to modify the type or strength of haptic effect that may be output by the pneumatic pressure generating device.

In the illustrative embodiment, the VR controller may further be configured to output vibration-based haptic effects to the user. For example, in some embodiments, the blades of a fan associated with an impeller motor may be of different sizes and weights. Thus, when the impeller motor activates a vibration force may be output. Alternatively, in some embodiments other types of haptic output devices may be included in the VR controller to output a broader range of haptic effects.

This illustrative example is given to introduce the reader to the general subject matter discussed herein and the disclosure is not limited to this example. The following sections describe various additional non-limiting examples and examples of the present disclosure.

### Illustrative Systems for Pneumatic Pressure Haptic Controllers

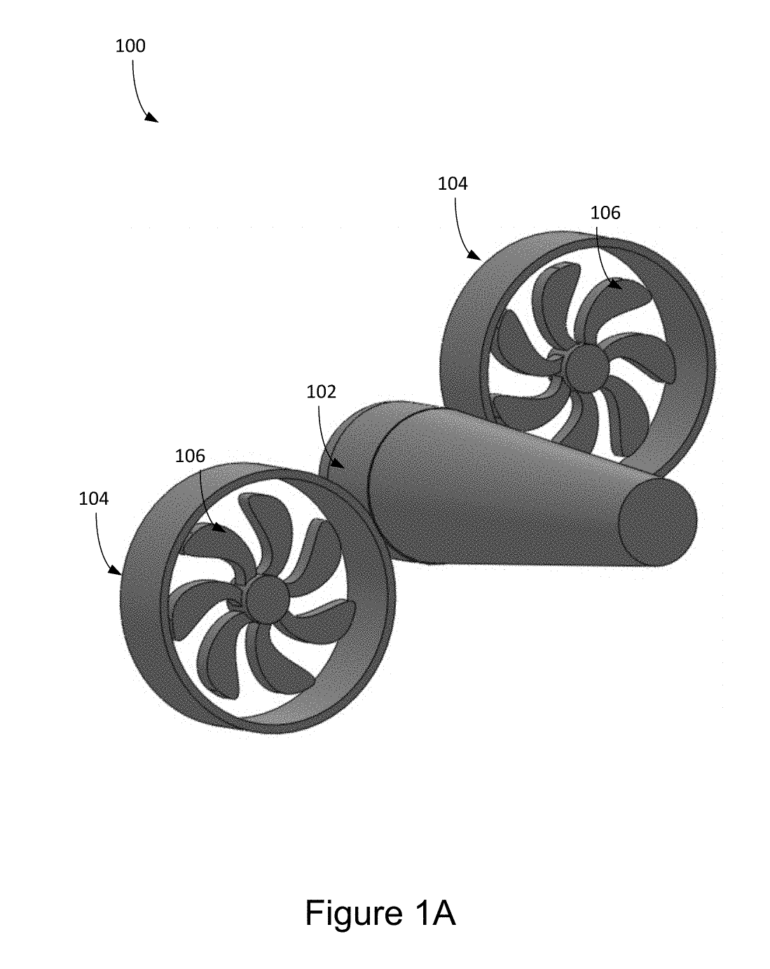

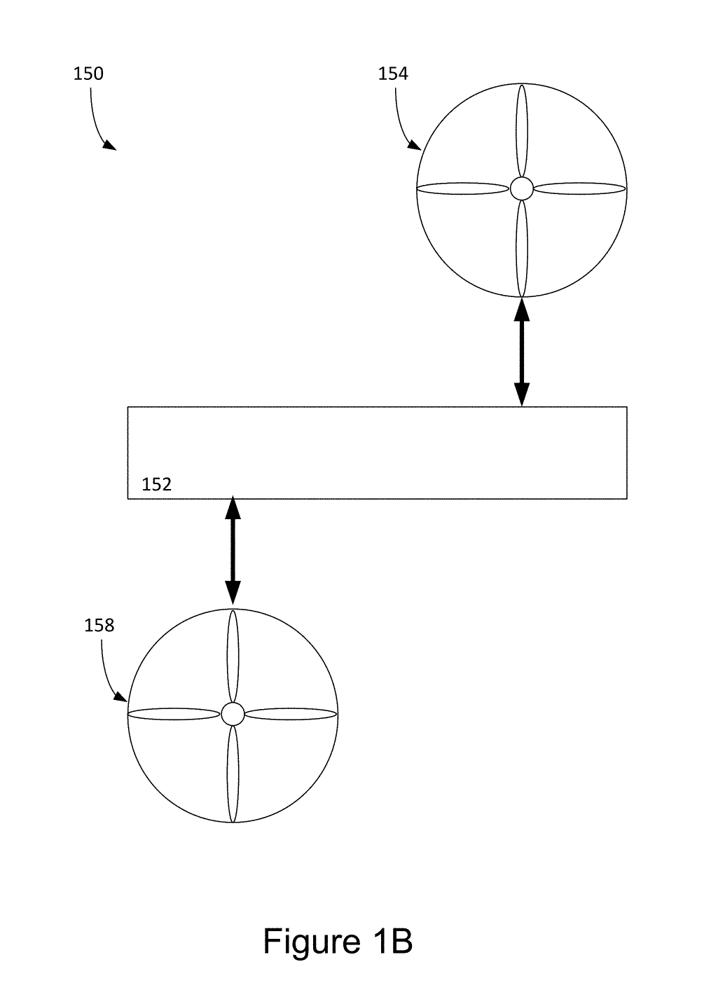

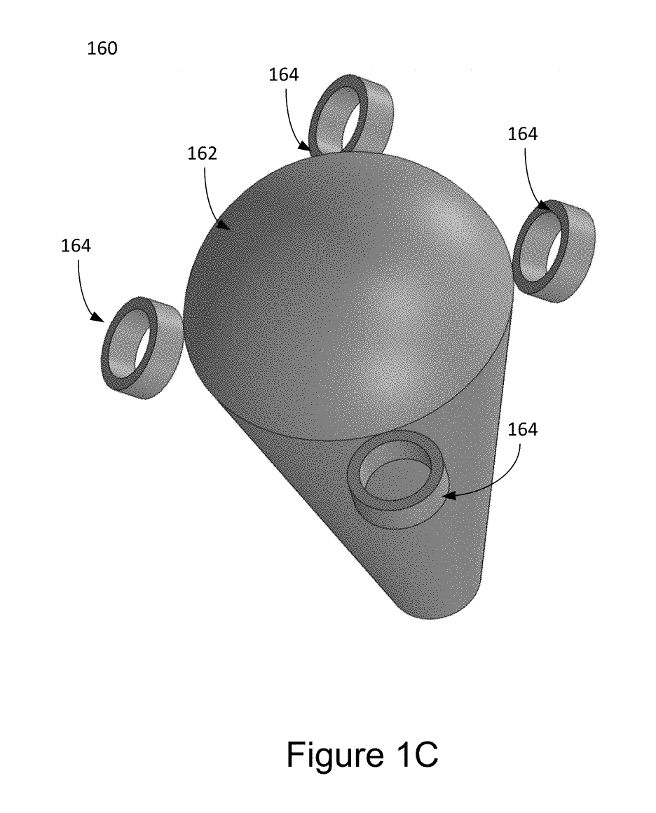

FIG. 1 shows an illustrative system 100 for pneumatic pressure haptic controllers. The system 100 comprises a controller 102 and two pneumatic pressure generating devices 104. The controller 102 comprises a controller configured for use in a VR application. For example, the controller 102 may comprise a device that is in wired or wireless communication with a gaming system. Thus, the controller 102 may comprise a handheld controller for the gaming system. In some embodiments, the controller may comprise independent processing capability. For example, in some embodiments, the controller 102 may comprise a mobile device (e.g., a handheld telephone or tablet computer). In such an embodiment the controller 102 may be in communication with a gaming system or may execute all or part of a Virtual or Augmented Reality application on its internal processor. Further, in some embodiments, the controller 102 may comprise a wearable device.

The system 100 further comprises two pneumatic pressure generating devices 104. In some embodiments, the pneumatic pressure generating devices 104 may comprise one or more impeller motors. In such an embodiment, an impeller motor comprises an electric motor configured to rotate a multi-blade fan or impeller 106. When the impeller motors are activated, they rotate the fans 106. In some embodiments, pneumatic pressure generating devices 104 are operated independently. In other embodiments, the pneumatic pressure generating devices 104 may be operated together, e.g., two impeller motors may rotate in opposite direction to cancel the torque from rotating blades. Further, the pneumatic pressure generating devices 104 may be operated at different or varying power levels. Further in some embodiments, impeller motors may be configured to rotate in either clockwise or counterclockwise and either in the same or opposing directions. In some embodiments, additional pneumatic pressure generating devices 104 may be affixed to controller 102. In some embodiments, the pneumatic pressure generating devices 104 may comprise one or more of a rotary motor to turn a fan or blower, a bellows, diaphragm, or a cylinder that generates pneumatic flow or pressure. Further, in some embodiments a bellows, diaphragm, or cylinder may be actuated (e.g., pushed or moved) by a smart material (e.g., piezo-ceramic, magnetostrictive, electroactive polymer, or some other smart material), solenoid, or linear motor to create pneumatic pressure.

When the pneumatic pressure generating devices 104 are activated they output forces which the user feels through the controller 102. These forces may comprise thrust force (the force caused by air displaced by the pneumatic pressure generating devices 104 and/or rotary forces as the fan 106 accelerates and spins. In some embodiments comprising a rotating impeller motor, fans 106 may be of different sizes. Thus, one impeller motor may output a larger force than the other motor. Further in some embodiments, the blades of fans 106 may be sized or weighted differently, causing the fan 106 to vibrate to output an additional haptic force to the user.

In other embodiments, the pneumatic pressure generating devices 104 may be mounted in different configurations. For example, in some embodiments the pneumatic pressure generating devices 104 may be internal to controller 102. In such an embodiment, controller 102 may comprise vents or holes to enable air to travel in/out of the pneumatic pressure generating devices 104.

As explained above, controller 102 is for use as a controller in a VR or AR environment. One example of how such a system might be used is for a VR game that allows a user to turn a steering wheel or other rotary device. As the user turns the steering wheel the pneumatic pressure generating devices 104 may be activated to output a force representing the force the user must overcome to turn the steering wheel in the virtual reality environment. Further, additional haptic effects (e.g., vibrations) may be output to indicate additional events in the VR environment (e.g., that the vehicle controlled by the steering wheel is passing over bumpy terrain. The pneumatic pressure generating devices 104 may be used to output additional types of forces, e.g., directional forces configured to simulate weight or drag as the user lifts or moves a virtual object.

Turning now to FIG. 1B, FIG. 1B shows another illustrative system 150 for pneumatic pressure haptic controllers according to one embodiment of the present disclosure. The system 150 comprises a controller 152 (similar to controller 102 described above) and two pneumatic pressure generating devices 154 and 158 (similar to the pneumatic pressure generating devices 104 described above).

As is shown in FIG. 1B, each of the pneumatic pressure generating devices 104 154 and 158 is configured to be removed and reattached. For example, the pneumatic pressure generating devices 154 and 158 may be part of a module that is magnetically coupled to controller 152. Thus, the pneumatic pressure generating devices 154 and 158 may be removed and reattached at different locations around controller 154. Further, the pneumatic pressure generating devices 154 and 158 may be faced in different directions, allowing for more complex array of forces to be output and perceived by the user.

The embodiment shown in FIG. 1B shows two pneumatic pressure generating devices 154 and 158 at opposite ends of the controller 152. In some embodiments, additional or pneumatic pressure generating devices may be included. Further, in some embodiments, the pneumatic pressure generating devices may be positioned at different locations or facing different directions.

In some embodiments a processor associated with the controller 152 may be configured to determine the haptic effect based in part on factors associated with the pneumatic pressure generating devices 154 and 158. For example, in some embodiments, repositioning the pneumatic pressure generating devices or including additional pneumatic pressure generating devices may change the center of mass of the combined system. The processor may be configured to determine that one or more of the pneumatic pressure generating devices has been moved and determine the haptic effect based in part on the changed center of mass. For example, the processor may determine that the haptic effect needs to be stronger or weaker to overcome the change in the center of mass to output the desired haptic effect. Similarly, in some embodiments the pneumatic pressure generating devices may have a different weight, or be replaced with pneumatic pressure generating devices of different weights. In such an embodiment, the processor may be configured to determine the weight and location of the pneumatic pressure generating devices and determine the haptic effect based in part on the different weights and locations (e.g., control the pneumatic pressure generating devices to generate higher pressure or volume of air to overcome the heavier weight of certain pneumatic pressure generating devices).

Further, in some embodiments, the pneumatic pressure generating devices may be positioned facing in different directions and/or at different angles. In such an embodiment, the processor may be configured to detect the angle and/or direction that the pneumatic pressure generating devices are facing and determine the haptic effect based in part on the angle and/or direction. For example, the processor may determine a certain strength of haptic effect or direction of rotation of an impeller based in part on the angle and/or direction that one or more of the pneumatic pressure generating devices are facing.

Further, in some embodiments, the processor may be configured to determine factors associated with the pneumatic pressure generating devices and determine the haptic effect based in part on one or more determined factors. For example, the processor maybe configured to determine the size of impeller blades, the pitch of impeller blades, the weight of impeller blades, the maximum power of an actuator, the amount of air that may be moved by a pneumatic pressure generating device, or some other factor. In such an embodiment, the processor may be configured to modify the haptic effect based on the determined factor. For example, the processor may determine that a certain desired haptic effect is available only with a pneumatic pressure generating device of a certain maximum power or weight. Further, in such an embodiment, the processor may determine the power level at which to operate an actuator based on one of the determined factors, e.g., a rotary pneumatic pressure generating device with a 3 cm impeller may need to be operated at a higher RPM than a rotary pneumatic pressure generating device with a 5 cm impeller to generate a desired haptic effect.

In some embodiments, the pneumatic pressure generating devices 154, 158 receive power directly from a power source on controller 152. Alternatively, in some embodiments, each of the pneumatic pressure generating devices comprises its own independent power source and receives control signals indicating, e.g., direction of rotation, speed of rotation, time of rotation, etc., from the controller 152 and/or from a remote device.

FIG. 1C shows another illustrative system 160 for pneumatic pressure haptic controllers according to one embodiment of the present disclosure. As shown in FIG. 1C, the controller 162 comprises four pneumatic pressure generating devices 164. In the embodiment shown in FIG. 1C, each of the four pneumatic pressure generating devices 164 has a different orientation and thus will output thrust in different direction. In some embodiments, a processor associated with controller 162 may be configured to detect the orientation of each of four pneumatic pressure generating devices 164 and use this orientation in determining the haptic effect and, e.g., the power and direction of operation of one or more of pneumatic pressure generating devices 164 to output the desired haptic effect. Further, in some embodiments, a processor may be configured to control actuators that shift the orientation of one or more of the pneumatic pressure generating devices 164 to output the desired haptic effect.

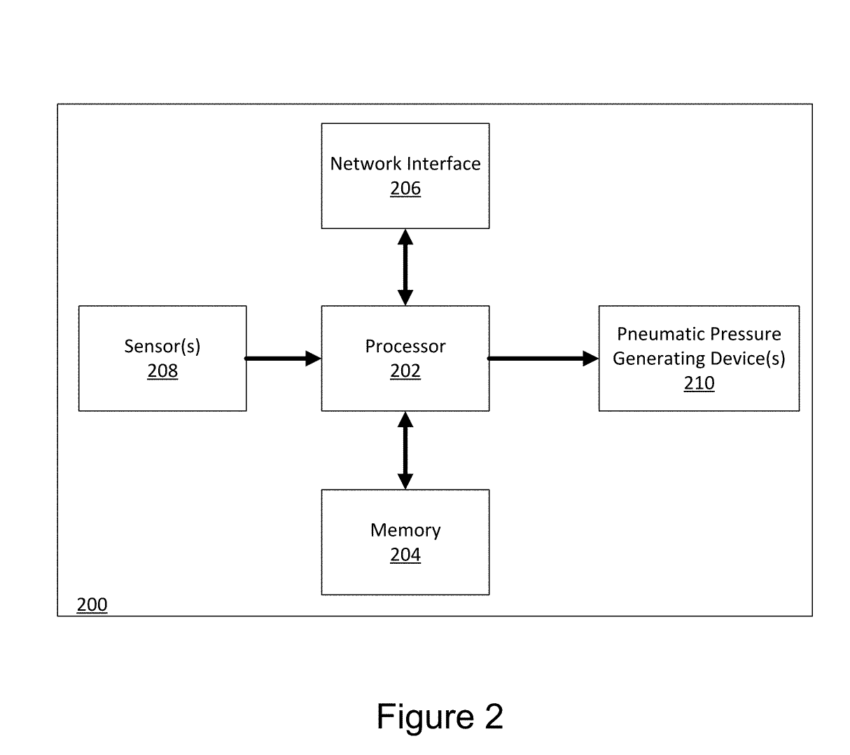

Turning now to FIG. 2, FIG. 2 shows another illustrative system 200 for pneumatic pressure haptic controllers according to one embodiment of the present disclosure. The system 200 may comprise a controller, e.g., similar to the controller 102 described above with regard to FIG. 1A. As shown in FIG. 2, the system 200 comprises a processor 202, memory 204, network interface 206, sensors 208, and pneumatic pressure generating devices 210.

As shown in FIG. 2, processor 202 is in communication with a memory 204, which can comprise any suitable tangible (and non-transitory) computer-readable medium such as Random Access Memory (RAM), Read Only Memory (ROM), Electrically Erasable Read Only Memory (EEPROM), or the like, embodies program components that configure operation of the computing device.

Processor 202 is further in communication with one or more network interfaces 206, which may facilitate communication with a remote device, e.g., a control device such as a gaming system or VR controller. Network interface 206 can represent one or more of any components that facilitate a network connection. Examples include, but are not limited to, wired interfaces such as Ethernet, USB, IEEE 1394, and/or wireless interfaces such as IEEE 802.11, Bluetooth, or radio interfaces for accessing cellular telephone networks (e.g., transceiver/antenna for accessing a CDMA, GSM, UMTS, or other mobile communications network).

Processor 202 is further in communication with one or more sensors 208. Sensor(s) 208 comprise one or more sensors configured to detect movement of a controller (e.g., accelerometers, gyroscopes, cameras, GPS, or other sensors). These sensors may be configured to detect user interaction that moves the controller in the X, Y, or Z plane. In some embodiments, processor 202 is configured to make determinations regarding movement and location based on data received from sensors 208. Further, in some embodiments, processor 202 is configured to transmit data received from sensors 208 to a remote device, e.g., using network interface 206. In some embodiments, this remote device may comprise a virtual reality system configured to determine haptic effects and transmit signals associated with those haptic effects back to processor 202.

In some embodiments, sensor 208 may be configured to detect multiple aspects of the user interaction. For example, sensor 208 may detect the speed and pressure of a user interaction, and incorporate this information into the interface signal. Further, in some embodiments, the user interaction comprises a multi-dimensional user interaction away from the device. For example, in some embodiments a camera associated with the device may be configured to detect user movements, e.g., hand, finger, body, head, eye, or feet motions or interactions with another person or object.

Processor 202 is further in communication with one or more pneumatic pressure generating devices 210. Pneumatic pressure generating devices 210 comprise components configured to generate pneumatic pressure. For example, in one embodiment pneumatic pressure generating devices 210 may comprise an electric motor that rotates a bladed fan or impeller. Alternatively, pneumatic pressure generating devices 210 may comprise a solenoid configured to apply pressure to a bellows, diaphragm, or a cylinder on order to generate pneumatic flow or pressure. Further, in some embodiments a bellows, diaphragm, or cylinder may be actuated (e.g., pushed or moved) by a smart material (e.g., piezo-ceramic, magnetostrictive, electroactive polymer, or some other smart material) to create pneumatic pressure.

In some embodiments, the pneumatic pressure generating devices 210 may comprise nozzles or other fittings configured to vary the flow or pressure of air moved by the pneumatic pressure generating devices 210. In some embodiments these fittings may be removable and replaceable to enable the user to modify the type of haptic effect output by the pneumatic pressure generating devices 210. In such an embodiment, processor 202 may be configured to detect a type of fitting on the pneumatic pressure generating devices 210 and determine the haptic effect based in part on that fitting. For example, the processor 202 may be configured to determine a direction of rotation, power level, or frequency of operation based in part on a diameter of nozzle affixed to pneumatic pressure generating devices 210.

In some embodiments, pneumatic pressure generating devices 210 may comprise impeller motors, e.g., one or more DC or AC electric motors coupled to a fan with a certain number blades (e.g., blades with 5 cm in diameter). In some embodiments the blades may comprise a different size. Further, in some embodiments, not all blades may be the same size, allowing the impeller motor to generate vibration when active. Further in some embodiments, multiple impeller motors may comprise different sized fans and thus output varying amounts of force. In such an embodiment, processor 202 may be configured to detect modification to an impeller motor (e.g., different blade size, weight, pitch, location, etc.) and determine the haptic effect based in part on that modification. For example, the processor 202 may be configured to determine a direction of rotation, power level, or frequency of operation based in part on a modification to one or more of the pressure generating devices 210.

In some embodiments, pneumatic pressure generating devices 210 may be configured to be repositioned at different locations throughout a controller. In such an embodiment, processor 202 may be configured to detect the location, direction, and angle of the pneumatic pressure generating devices 210 and determine the haptic effect based in part on that location. For example, the processor 202 may be configured to determine a direction of rotation, power level, or frequency of operation based in part on a location of pneumatic pressure generating devices 210 on a controller.

System 200 may further comprise one or more haptic output devices in communication with processor 202. The haptic output device may provide vibrotactile haptic effects. Some haptic effects may utilize an actuator coupled to a housing of the device, and some haptic effects may use multiple actuators in sequence and/or in concert. For example, in some embodiments, a surface texture may be simulated by vibrating the surface at different frequencies. In such an embodiment haptic output device may comprise one or more of, for example, a piezoelectric actuator, an electric motor, an electro-magnetic actuator, a voice coil, a shape memory alloy, an electro-active polymer, a solenoid, an eccentric rotating mass motor (ERM), or a linear resonant actuator (LRA). In some embodiments, haptic output device may comprise a plurality of actuators, for example an ERM and an LRA. In still other embodiments, the haptic output device may use non-actuated haptics (e.g., air, fluid, or ultrasonic output) that provide resistance as a means to convey rougher surfaces.

### Illustrative Method for Pneumatic Pressure Haptic Controllers

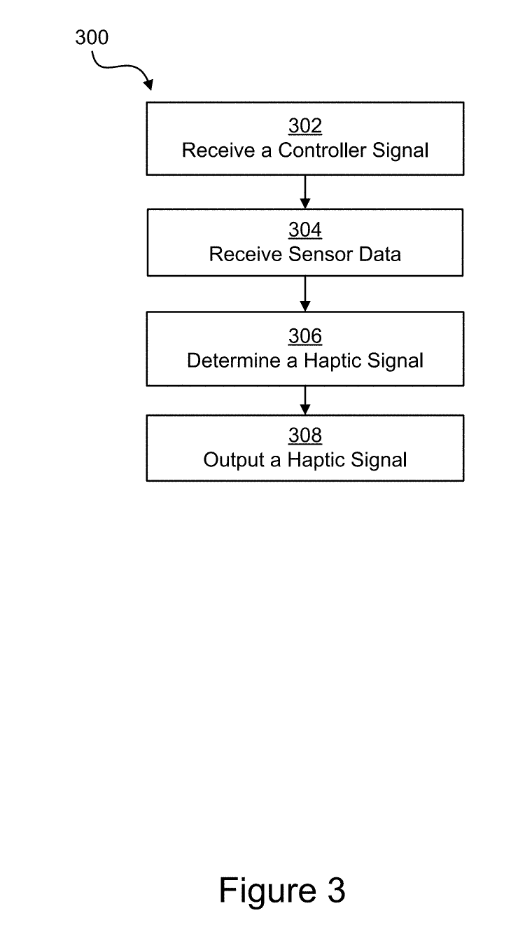

Referring now to FIG. 3, FIG. 3 shows an example method 300 for controlling pneumatic pressure haptic controllers. In some embodiments, the steps in FIG. 3 may be performed in a different order. Alternatively, in some embodiments, one or more of the steps shown in FIG. 3 may be skipped, or additional steps not shown in FIG. 3 may be performed. The steps below are described with reference to components described above with regard to the device 200 shown in FIG. 2.

The method begins at step 302 when processor 202 receives a controller signal. The processor 202, for example, may be a processor in a gaming console. The processor 202 may be in communication with the controller 200 via a wired or wireless connection and receiving sensor signals in order to control operations in a virtual reality application, e.g., a simulation or game. Further, in some embodiments, the processor 202 may be a component of the controller 200.

Next at step 304, the processor 202 also receives a sensor signal from a sensor 208 configured to determine data about controller 200. For example, a sensor signal may be received from a sensor 208 attached to a controller 200 and provide data about the position or movement of the controller 200.

The processor 202 uses the controller signal and sensor signal to determine a haptic effect 306. For instance, in one scenario, the user is playing a game and “touches” a virtual steering wheel in virtual reality. As the user turns the virtual steering wheel the processor 202 determines a haptic effect configured to simulate the resistance a user may feel when turning the steering wheel.

Next at step 308, the processor 202 outputs a haptic signal to one or more pneumatic pressure generating devices 210. The one or more pneumatic pressure generating devices 210 then output forces. These forces may comprise one or more of air flow and/or rotary torque. The user may perceive these forces while engaging in a virtual or augmented reality simulation with controller 200, and enhance the reality of that simulation.

In some embodiments, the one or more pneumatic pressure generating devices 210 may be reconfigurable. For example, the one or more pneumatic pressure generating devices 210 may be configured to be moved and repositioned throughout the controller. In such an embodiment, the processor 202 may be configured to detect the location, direction, and angle of the pneumatic pressure generating devices 210 and determine the haptic effect based in part on that location. For example, the processor 202 may be configured to determine a direction of rotation, power level, or frequency of operation based in part on the location, direction, and angle of pneumatic pressure generating devices 210 on a controller.

Further, in some embodiments, processor 210 may be able to determine other factors associated with the pneumatic pressure generating devices 210, e.g., the type of pneumatic pressure generating device or modifications (e.g., to include a nozzle or different types of blades on an impeller or fan of a rotary device). In such embodiments, the processor 210 may determine the haptic signal to output a desired haptic effect based in part on these modifications. For example, the processor 210 may be configured to determine the output power of a rotary motor coupled to an impeller and further determine the weight of the impeller to calibrate the power and/or frequency of the haptic signal to output a desired haptic effect.

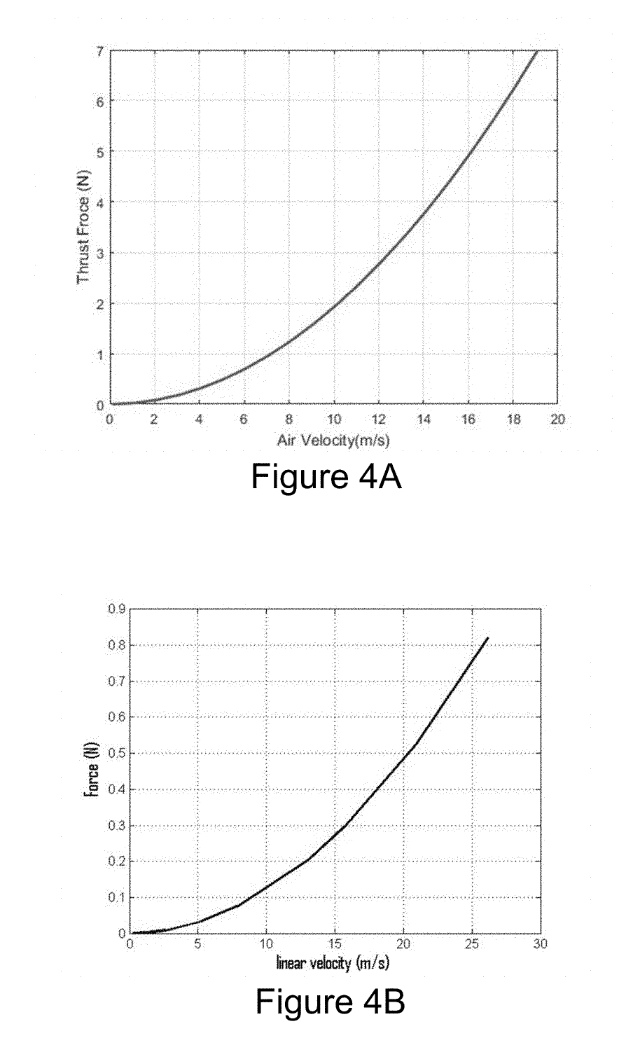

Turning now to FIG. 4A, which shows a graph comparing air velocity to linear force according to one embodiment of the present disclosure. As is shown in FIG. 4A as the velocity of air output by the one or more pneumatic pressure generating devices device increases, the thrust force also increases.

Turning now to FIG. 4B, which shows a graph comparing air velocity to linear force according to one embodiment of the present disclosure. As is shown in FIG. 4B as the linear velocity of air output by the one or more pneumatic pressure generating devices device increases, the thrust force also increases.

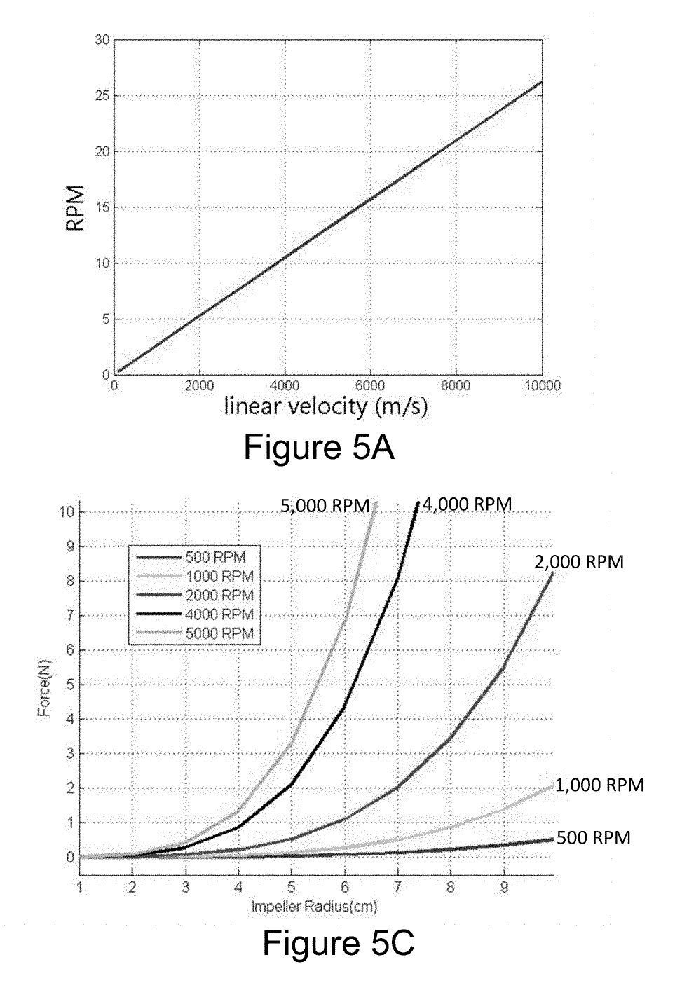

Turning now to FIG. 5A, which shows a graph comparing air velocity to Revolutions Per Minute (RPM) according to one embodiment of the present disclosure. As is shown in FIG. 5A as the RPMs for a rotary actuator increase, the linear velocity of air output by the actuator will similarly increase.

Turning now to FIG. 5B, which shows is a graph comparing impeller radius to force output according to one embodiment of the present disclosure. As is shown in FIG. 5B as the impeller radius and RPM increase, the force of air output from a rotary actuator increases.

Embodiments of the present disclosure may be utilized in a variety of different applications. For example, embodiments may be used in a variety of gaming application, such as car racing simulator, a simulator of turning a knob, or an simulation that involves rotating an object. For example, embodiments might be useful in commercial simulations as well, such as surgery or working in a weightless environment. Another example might be in simulating a cooking environment where actions such as picking up fruit or interacting with devices such as a blender could be simulated. Other examples might include working as an automobile or aircraft mechanic.

### General Considerations

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the present disclosure. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random access memory (RAM) coupled to the processor. The processor executes computer-executable program instructions stored in memory, such as executing one or more computer programs including a sensor sampling routine, selection routines, and other routines to perform the methods described above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, that may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A system comprising:
a controller;
an impeller motor coupled to the controller, the impeller motor configured to be removed and reattached to the controller; and
a processor coupled to the impeller motor and configured to:
receive a controller signal;
determine a haptic signal based in part on the controller signal; and
output the haptic signal to the impeller motor to output a haptic effect.

2. The system of claim 1, further comprising a location sensor, and wherein the processor is further configured to determine the haptic signal based in part on data received from the location sensor.

3. The system of claim 1, wherein the controller comprises a user interface device for a virtual reality system.

4. The system of claim 3, wherein the processor receives the controller signal from the virtual reality system.

5. The system of claim 1, wherein the impeller motor comprises a plurality of impeller motors.

6. The system of claim 5, wherein each of the impeller motors is configured to be removed and reattached to the controller.

7. The system of claim 6, wherein the processor is further configured to determine a location of each of the impeller motors and determine the haptic signal based in part on the location of each of the impeller motors.

8. The system of claim 6, wherein each of the impeller motors is magnetically coupled to the controller.

9. A method comprising:
receiving a controller signal by a controller;
determining a haptic signal based in part on the controller signal; and
outputting the haptic signal to an impeller motor to output a haptic effect, the impeller motor coupled to a controller and configured to be removed and reattached to the controller.

10. The method of claim 9, further comprising, determining the haptic signal based in part on data received from a location sensor.

11. The method of claim 9, wherein the impeller motor is coupled to a controller comprising a user interface device for a virtual reality system.

12. The method of claim 11, wherein the controller signal is received from the virtual reality system.

13. The method of claim 9, wherein the impeller motor comprises a plurality of impeller motors.

14. The method of claim 13, wherein each of the impeller motors is configured to be removed and reattached to a controller.

15. The method of claim 14, further comprising:
determining a location of each of the impeller motors; and
determining the haptic signal based in part on the location of each of the impeller motors.

16. The method of claim 14, wherein each of the impeller motors is magnetically coupled to the controller.

17. A non-transitory computer readable medium comprising program code, which when executed by a processor is configured to cause the processor to:
receive a controller signal;
determine a haptic signal based in part on the controller signal; and
output the haptic signal to an impeller motor to output a haptic effect, the impeller motor coupled to a controller and configured to be removed and reattached to the controller.

18. The non-transitory computer readable medium claim 17, further comprising program code, which when executed by the processor is configured to cause the processor to determine the haptic signal based in part on data received from a location sensor.

19. The non-transitory computer readable medium claim 17, wherein the impeller motor is coupled to a controller comprising a user interface device for a virtual reality system.

20. The non-transitory computer readable medium claim 19, wherein the impeller motor is configured to be removed and reattached to the controller.
